(19) United States
(12) Patent Application Publication
(10) Pub. No.: US 2012/0224907 A1
(43) Pub. Date: Sep. 6, 2012

(54) PRINTER AND CONTROL METHOD THEREOF, AND COMPUTER-READABLE STORAGE MEDIUM

(75) Inventors: Yasutoshi Serizawa, Shizuoka (JP); Kiyoshi Morino, Shizuoka (JP); Noriyuki Watanabe, Singapore (SG)

(73) Assignee: TOSHIBA TEC KABUSHIKI KAISHA, Tokyo (JP)

(21) Appl. No.: 13/409,423

(22) Filed: Mar. 1, 2012

(30) Foreign Application Priority Data
Mar. 3, 2011 (JP) 2011-46910

(51) Int. Cl. B41J 11/70

(52) U.S. Cl. 400/621

(57) ABSTRACT

According to one embodiment, a printer includes a cutter configured to cut the transferred paper. A mark sensor is provided in the printer to detect marks attached at a certain interval on the paper. The printer further includes a control unit to determine a driving timing of the cutter depending on a driving amount of a motor determined after a first mark on the paper is detected by the mark sensor after the printing by the head is terminated. An adjustment unit is further provided to determine a driving amount of the motor until the mark sensor detects a second mark after the first mark is detected, and adjust the driving amount of the motor for determining a driving timing of the cutter based on the difference between the detected driving amount and a predetermined standard driving amount.

### CROSS-REFERENCE TO RELATED APPLICATION

This application is based upon and claims the benefit of priority from Japanese Patent Application No. 2011-046910, filed on Mar. 3, 2011, the entire contents of which are incorporated herein by reference.

### FIELD

Embodiments described herein relate generally to a printer for performing printing on paper while transferring the paper, a method of controlling the printer, and a computer-readable storage medium comprising computer-executable instructions of controlling the printer.

### BACKGROUND

Conventionally, a thermal printer has been used for performing printing on paper while transferring the paper.

In such printers, a “deviation” between a theoretical paper transfer distance and an actual paper transfer distance may occur due to various reasons such as deterioration, looseness of a transfer path, abrasion of a roller, change in a frictional force of the roller due to paper dust or dust attached to the roller, static electricity, and the like. This deviation may also result in a deviation at a cut position of paper after printing is terminated.

The detection and correction of such deviations at the cut position is left to a naked-eye decision and manual operation of a user or an operator. This is a big burden for the user or the operator.

### BRIEF DESCRIPTION OF THE DRAWINGS

FIG. 1 is a view showing an overall configuration of a printer, according to some embodiments.

FIG. 2 is a view showing the configuration of a portion of the printer and thermal paper, according to some embodiments.

FIG. 3 is a block diagram of a control circuit of the printer, according to some embodiments.

FIG. 4 is a flowchart for explaining processing at a usual time of the printer, according to some embodiments.

FIG. 5 is a flowchart for explaining processing at an adjustment time of the printer, according to some embodiments.

### DETAILED DESCRIPTION

According to one embodiment, a printer includes a transfer mechanism, a motor, a head, a cutter, a mark sensor, a control unit and an adjustment unit. The transfer mechanism is provided to transfer paper. The motor is provided to drive the transfer mechanism. The head is provided to execute printing on paper. The cutter is disposed at a lower side than a position of the head in a transfer direction of the paper and configured to cut the transferred paper. The mark sensor is provided in the printer to detect marks attached at a certain interval on the paper along the transfer direction of the paper. The control unit is provided to determine a driving timing of the cutter depending on a driving amount of the motor determined after a first mark on the paper is detected by the mark sensor after the printing by the head is terminated. An adjustment unit is further provided to determine a driving amount of the motor until the mark sensor detects a second mark after the first mark is detected, and adjust the driving amount of the motor for determining a driving timing of the cutter based on the difference between the detected driving amount and a predetermined standard driving amount.

Reference will now be made in detail to various embodiments, examples of which are illustrated in the accompanying drawings. In the following detailed description, numerous specific details are set forth in order to provide a thorough understanding of the present subject matter. However, it will be apparent to one of ordinary skill in the art that the present subject matter may be practiced without these specific details. In other instances, well-known methods, procedures, systems, and components have not been described in detail so as not to unnecessarily obscure aspects of the various embodiments.

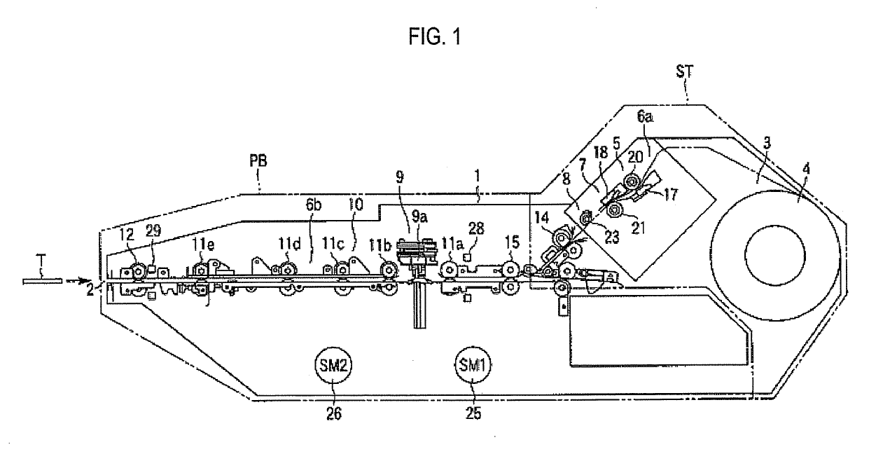

In FIG. 1, reference numeral 1 denotes a printer which includes a fascia portion 2 on a front portion of printer 1, which is used both as the entrance for a passbook T and as an exit for a statement paper. The printer 1 also includes a paper setting portion 3 on a rear portion. Roll-type thermal paper 4 is set on the paper setting portion 3. The set thermal paper 4 is drawn out by a first transfer unit 5 and guided to a transfer path 6a. A thermal print unit 7 and a cutting portion 8 are installed on the transfer path 6a.

A second transfer unit 10 is disposed within the printer 1. The second transfer unit 10 includes a transfer path 6b continuously coupled to the transfer path 6a, pairs of transfer rollers 11a to 11e installed on the transfer path 6b, a pair of entry rollers 12, and a pair of feed rollers 15, which transfers the passbook T inserted into the fascia portion 2 while simultaneously transferring the thermal paper 4 from the transfer path 6a toward the fascia portion 2. A dot print portion 9 having a 24-pin dot matrix head 9a is installed between the pair of transfer rollers 11a and 11b on the transfer path 6b. The pair of entry rollers 12 takes in the passbook T inserted into the fascia portion 2, and takes out a printing-finished passbook T or statement paper from the fascia portion 2. A paper sensor 28 for detecting a front end portion of the thermal paper 4 is disposed at an entry side of the second transfer unit 10. A passbook sensor 29 for detecting an insertion of the passbook T is installed in the vicinity of the pair of entry rollers 12 on the second transfer unit 10.

The cutting portion 8 includes a rotary-type cutter 23, and the thermal paper 4 is cut by a rotation of the cutter 23. The cut piece of the thermal paper 4 is discharged as a statement paper.

The thermal print unit 7 has a first thermal head 17 for rear surface printing and a second thermal head 18 for surface printing at positions spaced apart from each other along a transfer direction of the thermal paper 4. The first and second platen rollers 20 and 21 are rotatably pressed against these thermal heads 17 and 18. As the thermal paper 4 is transferred by the thermal heads 17 and 18 and the platen rollers 20 and 21, information is printed on both sides thereof by the thermal heads 17 and 18.

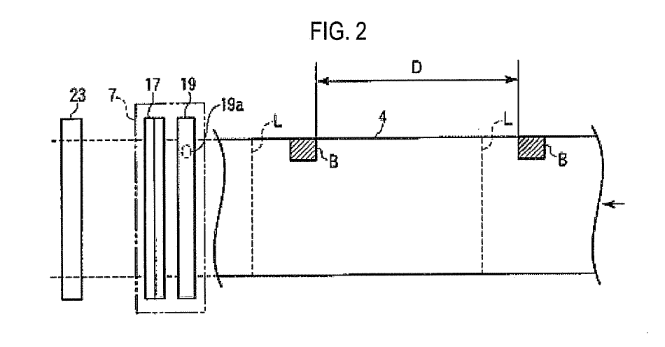

Also, as shown in FIG. 2, the thermal print unit 7 has a black mark detection unit 19 formed at a position in front of the thermal head 17 in the transfer direction of the thermal paper 4. The black mark detection unit 19 has a mark sensor 19a for optically detecting a black mark B previously attached to a rear surface of the thermal paper 4. The black mark B, which may have a rectangular shape and is used as a reference for determining a cut position of the cutter 23, is printed at an end position of the thermal paper 4 in a width direction (which is perpendicular to the transfer direction) and at every certain interval D along the transfer direction.

Referring again to FIG. 1, the first transfer unit 5 has the first and second platen rollers 20 and 21 which are rotatably in pressure-contact with the thermal heads 17 and 18 and the pair of feed rollers 14 for transmitting a statement paper cut by the cutter 23 to the second transfer unit 10. A stepping motor (SM1) 25 is installed to drive the platen rollers 20 and 21, the cutter 23, and the pair of feed rollers 14. Also, a stepping motor (SM2) 26 is installed to drive the pairs of transfer rollers 11a to 11e, the pair of entry rollers 12, and the pair of feed rollers 15 of the second transfer unit 10.

A statement printer ST is configured to execute printing on the thermal paper 4 while transferring the thermal paper 4 from the paper setting unit 3 to the first transfer unit 5 and its peripheral portion. Additionally, a passbook printer PB may be configured to execute printing on the passbook T, while transferring the passbook from the pair of feed rollers 15 to the second transfer unit 10 and its peripheral portion, and also execute transferring the thermal paper 4 when the statement printer ST performs printing.

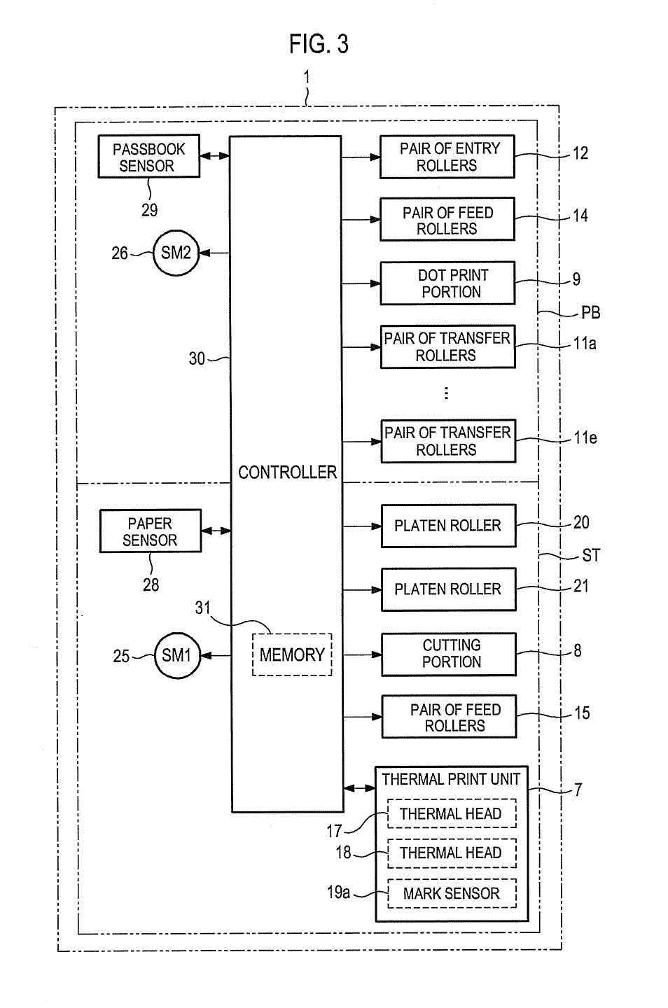

FIG. 3 illustrates a control circuit of the printer 1 according to some embodiments.

Reference numeral 30 denotes a controller, which controls the entire operation of the statement printer ST and the passbook printer PB. Components of the statement printer ST and those of the passbook printer PB are connected to the controller 30, respectively.

Further, the controller 30 includes a control unit and an adjustment unit (not shown) as the functional modules for executing a control program stored in an internal memory 31.

(1) The control unit of the controller 30 is configured to determine a driving timing of the cutter 23 depending on the number of driving steps (the amount of driving) of the stepping motor 25 made after the mark sensor 19a detects a mark, when printing by means of any one of the thermal heads 17 and 18 is terminated. Specifically, after printing by means of the thermal heads 17 and 18 is terminated, the control unit detects the number of driving steps A0 made after the mark sensor 19a detects a mark. When the detected number A0 of driving steps reaches a predetermined set value Ac, the control unit drives the cutter.

(2) The adjustment unit of the controller 30 is configured to detect the number of driving steps of the stepping motor 25 during a time period from when the mark sensor 19a detects a black mark B until the mark sensor 19a detects a next black mark B, which may be performed periodically (e.g., every predetermined number of minutes, days, months, etc.) or at a predetermined detection time when the printer 1 is powered on. The adjustment unit then adjusts the number of driving steps of the stepping motor 25 for determining a driving timing of the cutter 23 based on the difference between the detected number of driving steps and a predetermined number of standard driving steps (a standard amount of driving).

Specifically, the adjustment unit may include a unit for detecting the number of driving steps A1 of the stepping motor 25 until the mark sensor 19a detects a next black mark B after detecting a black mark B. The detection of the number of driving steps A1 may be performed periodically at a predetermined number Ns of intervals. Further, the adjustment unit may include a unit for integrating (or summing) the numbers A1 of driving steps, which are detected at the number Ns of intervals, to generate, for example, an integration value A2, a unit for calculating an average value A3 (=A2/Ns) of the integration value A2, and a unit for calculating the difference A4 (=Ax−A3) between thee calculated average value A3 and a predetermined standard number of driving steps Ax. Another unit is provided in the adjustment unit for calculating an adjustment value with respect to the number of driving steps of the stepping motor 25 based on the difference A4 if an absolute value of the calculated difference A4 is larger than a predetermined threshold value As. Also, the adjustment unit further includes a unit for updating and storing the calculated adjustment value in the internal memory 31, and a unit for correcting the set value Ac based on the stored adjustment value. Here, the standard number of driving steps Ax indicates a standard number of driving steps required for transferring a paper in the distance D between the two adjacent black marks B by the stepping motor 25.

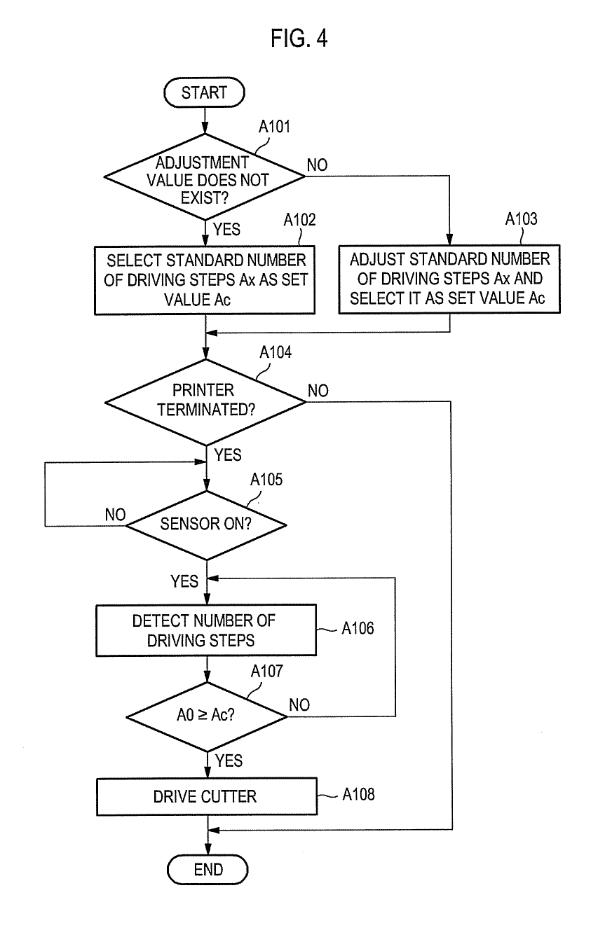

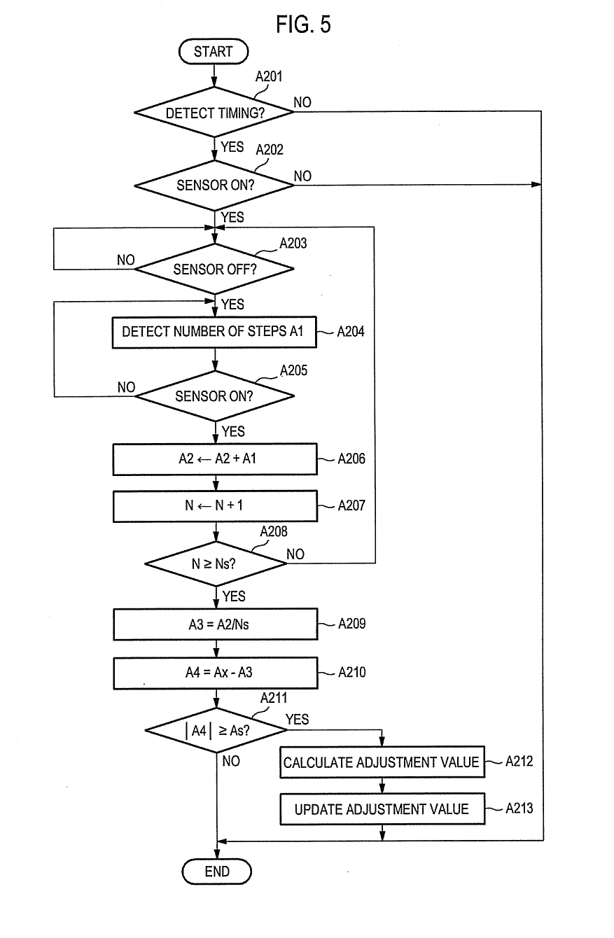

Next, the operation of the printer according to one embodiment will be described. FIG. 4 illustrates a flowchart of a normal printing process performed on the thermal paper 4, and while FIG. 5 illustrates a flowchart of a cutting-adjusted printing process performed on the thermal paper 4.

When the passbook T is printed, the passbook T is transferred by the passbook printer PB and dot matrix printing is executed on the passbook T. In printing the thermal paper 4, the thermal paper 4 is transferred by the statement printer ST and the passbook printer PB and, at the same time, the thermal paper 4 is thermally printed by the statement printer ST.

Immediately after the printer 1 is used for the first time or when the printer 1 is used for a short period of time, an adjustment value does not exist yet in the memory 31 (YES in Act A101), and the standard number of driving steps Ax is selected as the set value Ac of determining the cut position (Act A102). As the printer 1 performs a printing operation and associated cutting adjustment process, an adjustment value is created and updated in the memory 31 (NO in Act A101). Also, the standard number of driving steps Ax is multiplied by the adjustment value, and the multiplication result is selected as the set value Ac for determining the cut position (Act A103).

After the printing is terminated by any one of the thermal heads 17 and 18 (YES in Act A104), the black mark B is detected by the mark sensor 19a (sensor ON; YES in Act A105). Further, the number of driving steps A0 of the stepping motor 25 after the detection of the black mark B is detected (Act A106). When the number of driving steps A0 reaches the selected set value Ac (YES in Act A107), the cutter 23 is driven (Act A108). In case of FIG. 2, after the black mark B passes through the mark sensor 19a, for example, a dotted line L becomes a cut position.

Meanwhile, as shown in FIG. 5, at predetermined detection timing intervals (e.g., every several days or every few months) or when the printer 1 is powered on (YES in Act A201), the following operations are performed. In particular, when a black mark B on the thermal paper B transferred enters a corresponding position with the mark sensor 19a (sensor ON; YES in Act A202) and then gets out of the corresponding position with the mark sensor 19a (sensor OFF; YES in Act A203), the number of driving steps A1 of the stepping motor 25 is detected (Act A204). Then, when a next black mark B enters the corresponding position with the mark sensor 19a (sensor ON; YES in Act A205), the detected number of driving steps A1 is added to the integration value A2 (YES in Act A206). This integration operation is followed by increasing the number of integrations N by 1 (Act A207), and the number of integrations N and the prescribed number Ns are compared (Act A208). When the number of integrations N does not reach the prescribed number Ns (NO in Act A208), Acts A203 to A207 are repeatedly performed.

When the number of integrations N reaches the prescribed number Ns (YES in Act A208), an average value A3 (=A2/Ns) of the integration value A2 is calculated (Act A209), and the difference A4 (=Ax−A3) between the average value A3 and the standard number of driving steps Ax is calculated (Act A210). An absolute value of the difference A4 and the predetermined certain value As are then compared (Act A211).

When the absolute value of the difference A4 is smaller than the threshold value As (YES in Act A211), the processing is terminated.

When the absolute value of the difference A4 is equal to or greater than the threshold value As (NO in Act A211), an adjustment value with respect to the number of driving steps of the stepping motor 25 is calculated based on the difference A4 (Act A212). The calculated adjustment value is updated and recorded in the memory 31 (Act A213).

When the distance D between the two adjacent black marks B is, for example, 112 mm (=about 4.4 inches), the standard number of driving steps Ax corresponding to the distance D is, for example, “1790,” and “2148” is calculated as the average value A3. In this case, a theoretical paper transfer distance per step is about 0.062 mm, while an actual paper transfer distance per step is about 0.052 mm which is smaller than the theoretical paper transfer distance per step. Thus, the “deviation” in the paper transfer distance is 0.010 mm. This deviation also causes a deviation of the cut position of the thermal paper 4.

In this case, since the difference A4 is −358 (=1790−2148), if the threshold value As is, for example, 10, the absolute value of the difference A4 is equal to or greater than the threshold value As (NO in Act A211), and thus, 120% (=2148/1790) is calculated as an adjustment value.

When, for example, “1611” is calculated as the average value A3, the actual paper transfer distance per one step is about 0.069 mm, which is greater than the theoretical paper transfer distance.

In this case, since the difference A4 is +179 (=1790−1611), if the threshold value As is, for example, “10” as mentioned above, the absolute value of the difference A4 is equal to or greater than the threshold value As (NO in Act A211), and thus, 90% (=1611/1790) is calculated as an adjustment value.

According to the above embodiments, the “deviation” in the cut position of the thermal paper 4 is automatically detected, and moreover, it can be automatically corrected, thereby cutting the thermal paper 4 at an appropriate position. Accordingly, the reliability of the printer can be improved and the user's burden can be considerably reduced.

In addition, in the foregoing embodiments, the cutting-adjustment processing is executed periodically or when power is supplied to the printer. However, in some alternative embodiments, the number of marks detected by the mark sensor 19a may be determined as a usage amount of thermal paper (a transfer amount of thermal paper) and the adjusting process may be executed when the usage amount is equal to or greater than a predetermined amount. Further, the timing for executing the adjustment process may be determined based on at least one of periodicity, power supply, the usage amount of thermal paper. Alternatively, the adjustment process may be continuously executed during a printing operation.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus or can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) in the apparatus.

While certain embodiments have been described, these embodiments have been presented by way of example only, and are not intended to limit the scope of the inventions. Indeed, the novel embodiments described herein may be embodied in a variety of other forms and/or any number of these embodiments may be combined in various ways; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer, comprising:
a transfer mechanism configured to transfer paper;
a motor configured to drive the transfer mechanism;
a head configured to execute printing on paper;
a cutter disposed at a lower side than a position of the head in a transfer direction of the paper and configured to cut the transferred paper;
a mark sensor configured to detect marks attached at a certain interval on the paper along the transfer direction of the paper;
a control unit configured to determine a driving timing of the cutter depending on a driving amount of the motor determined after a first mark on the paper is detected by the mark sensor after the printing by the head is terminated; and
an adjustment unit configured to determine a driving amount of the motor until the mark sensor detects a second mark after the first mark is detected, and adjust the driving amount of the motor for determining a driving timing of the cutter based on the difference between the detected driving amount and a predetermined standard driving amount.

2. The printer of claim 1, wherein the control unit is configured to determine the driving amount of the motor determined after the mark sensor detects the first mark after the printing by the head is terminated, and when the detected driving amount reaches a predetermined set value, the control unit drives the cutter, and
wherein the adjustment unit is configured to sum the driving amounts of the motor sequentially detected each time when the mark sensor detects a next mark after detecting a current mark, obtain an average value of the detected driving amounts of the motor, and correct the set value based on the difference between the average value and the predetermined standard driving amount.

3. The printer of claim 2, wherein the adjustment unit comprises:
a unit configured to detect driving amounts of the motor until the mark sensor detects the next mark after detecting the current mark, at a predetermined number of intervals;
a unit configured to sum the detected driving amounts to generate an integration value;
a unit configured to calculate an average value of the integration value;
a unit configured to calculate the difference between the calculated average value and the predetermined standard driving amount;
a unit configured to calculate an adjustment value with respect to the driving amount of the motor based on the calculated difference when the calculated difference is equal to or greater than a predetermined value;
a unit configured to update and store the calculated adjustment value; and
a unit configured to correct the set value based on the stored adjustment value.

4. The printer of claim 1, wherein the motor is a stepping motor, and
wherein the control unit is configured to detect a number of driving steps of the stepping motor after the mark sensor detects the first mark after the printing by the head is terminated, and when the detected number of driving steps reaches a preset value, the control unit drives the cutter, and
the adjustment unit is configured to sum driving amounts of the motor sequentially detected each time when the mark sensor detects a next mark after detecting a current mark, obtains an average value of the detected driving amounts of the motor, and corrects the preset value based on the difference between the average value and a predetermined standard number of driving steps.

5. The printer of claim 1, wherein the adjustment unit is configured to detect the driving amount or the number of driving steps at a predetermined detection timing, or when the usage amount of paper is equal to or greater than a predetermined amount.

6. A computer-readable storage medium comprising computer-executable instructions for controlling a printer, which comprises a transfer mechanism for transferring paper, a motor for driving the transfer mechanism, a head for executing printing on paper, a cutter disposed at a lower side than a position of the head in a transfer direction of the paper for cutting the transferred paper, a mark sensor for detecting marks attached at a certain interval on the paper along the transfer direction of the paper, and a controlling computer, the instructions, when executed by the controlling computer, causing the printer to realize the operations of:
determining a driving timing of the cutter depending on a driving amount of the motor after the mark sensor detects a first mark after the printing by the head is terminated; and
detecting a driving amount of the motor until the mark sensor detects a second mark after detecting the first mark, and adjusting the driving amount of the motor for determining a driving timing of the cutter based on the difference between the detected driving amount and a predetermined standard driving amount.

7. A method for controlling a printer, which comprises a transfer mechanism for transferring paper, a motor for driving the transfer mechanism, a head for executing printing on paper, a cutter disposed at a lower side than a position of the head in a transfer direction of the paper for cutting the transferred paper, a mark sensor for detecting marks attached at a certain interval on the paper along the transfer direction of the paper, the method comprising:
determining a driving timing of the cutter depending on a driving amount of the motor after the mark sensor detects a first mark after the printing by the head is terminated;
detecting a driving amount of the motor until the mark sensor detects a second mark after detecting the first mark; and
adjusting the driving amount of the motor for determining a driving timing of the cutter based on the difference between the detected driving amount and a predetermined standard driving amount.
